(19) United States
(12) Patent Application Publication
(10) Pub. No.: US 2003/0059540 A1
(43) Pub. Date: Mar. 27, 2003

(54) Substrate comprising a thick film consisting of an inorganic gel, glass, vitroceramic or ceramic material, a method for the production of the same and the use thereof

(76) Inventors: Anette Berni, Kaeshofen (DE); Andreas Frantzen, Saarbruecken (DE); Axel Kalleder, Blieskastel (DE); Martin Mennig, Quierschied (DE); Navin Suyal, Edinburgh (GB); Helmut Schmidt, Saarbruecken-Guedingen (DE)

Correspondence Address: HELLER EHRMAN WHITE & MCAULIFFE LLP, 275 MIDDLEFIELD ROAD, MENLO PARK, CA, 94025-3506, US

(21) Appl. No.: 10/240,878

(22) PCT Filed: Apr. 12, 2001
(86) PCT No.: PCT/EP01/04215

(30) Foreign Application Priority Data
Apr. 14, 2000 (DE) 10018697.1

(51) Int. Cl. B05D 3/02

(52) U.S. Cl. 427/376.1

(57) ABSTRACT

Process for producing substrates with a layer comprising an inorganic gel, glass, glass-ceramic or ceramic material, in which a coating composition comprising nanosize particles and water soluble organic flexibilizers is applied to the substrate and heat treated. Crack-free and transparent thick films can be obtained by means of the process. The coated substrates are particularly suitable for optical, optoelectronic, electronic, micromechanical or dirt-repellent components.

The present invention relates to a substrate with at least one thick film comprising an inorganic gel, glass, glass-ceramic or ceramic material, a process for producing substrates with at least one layer comprising inorganic gel, glass, glass-ceramic or ceramic material and their use, e.g. in optics, optoelectronics or electronics.

SiO₂ layers and doped SiO₂ layers having a thickness in the micron range are suitable for a variety of applications in the field of optics and optoelectronics. Thus, SiO₂ layers having thicknesses in the micron range are employed as dielectric insulation layers on silicon for semiconductor production. A further important area is the production of sufficiently thick buffer layers on silicon for the production of integrated optical components. SiO₂ layers doped with various ions are employed in the production of passive and active planar optical waveguides.

The production of SiO₂ layers having a thickness in the micron range is generally carried out via thermal oxidation or flame hydrolysis. Both methods are very costly and tune-consuming. For buffer layers for producing planar waveguides, an SiO₂ layer having a thickness of 10-15 μm is required. For the production of materials containing dopants to adjust the index of reflection, e.g. Pb, P, Al, or dopants for producing active materials, e.g. Er, there is the problem that sufficiently high dopant concentrations cannot be achieved by means of flame hydrolysis.

The sol-gel process is an alternative for the production of thick SiO₂ layers and doped SiO₂ layers. The incorporation of suitable ions for producing amplifying materials can be achieved without problems via the sol-gel process. Compared to the conventional synthetic methods, homogeneous materials having high dopant concentrations are obtained. The sol-gel process thus offers an alternative for the production of these components. However, it has not yet been possible to produce crack-free, densified, high-purity SiO₂ layers or doped SiO₂ layers having thicknesses in the micron range on silicon or SiO₂ as substrate material.

In the formation of inorganic sol-gel layers, evaporation of the solvent during the sol-gel transition and in the further course of the thermal treatment for densification and for burning out residual organics and also the collapse of the pores resulting therefrom lead to shrinkage of the coating, which, due to the chemical bond to the substrate, can occur only in a direction perpendicular to the surface.

This results in mechanical stresses in the coating and at the interface to the substrate, which are determined not only by the shrinkage of the densifying coating but also by the thermal expansion of substrate and coating during heating and cooling. Those skilled in the art will know that the stresses increase with thickness of the layer, so that a limit of about <1 μm applies to all known layer systems. In the case of thicker coatings, crack-free single coatings cannot be formed.

As starting material for sol-gel SiO₂ layers on silicon wafers and on glass substrates, use is frequently made of tetraethoxysilane (TEOS) in ethanol which has been hydrolyzed by means of aqueous hydrochloric acid or water. Maximum layer thicknesses of only 400 nm have been able to be achieved in this way, or coarse-pored layers which are unusable for optical applications because of their porosity have been obtained.

Williams et al., Proc. SPIE-Int. Soc. Opt. Eng. (1994), 2288 (Sol-Gel-Optics III), 55-56, describe the production of SiO₂ layers starting from colloidal SiO₂ sol which has been mixed with polysiloxanes. The thickness obtained for the crack-free layers densified by drying at 150° C. was in the range from 100 nm to 1 μm.

The production of thick SiO₂ layers by means of electrophoresis is described by Nishimori et al., J. Sol-Gel Sci. Technol. (1996), 7(3), 211-216. The synthesis of the layers is carried out starting from SiO₂ particles and polyacrylic acid. The layer is applied to stainless steel by means of electrophoretic deposition; sintering is not carried out. Layers produced by means of electrophoresis have the disadvantage that they have a high porosity after densification and are not transparent. Furthermore, electrophoretic deposition has the disadvantage that the substrates have to display metallic conductivity.

The production of wave-guiding layers is carried out on the basis of inorganic sol-gel materials, and the problem of the low layer thickness occurs in all cases. As wave-guiding materials, SiO₂-TiO₂ layers have been discussed. Other doping materials apart from TiO₂ for SiO₂ layers are P₂O₅ and GeO₂.

Only very thin layers which are unsuitable for many applications, e.g. production of multimode waveguides, can be achieved by means of customary sol-gel processes. Although thick layers can be obtained in the electrophoretic deposition of predensified SiO₂ particles on metal substrates, electrophoretic coating processes are unsuitable in principle in the case of substrates as are used in optics and optoelectronics (e.g. Si, glass). In addition, transparent layers as are necessary for optical applications cannot be obtained.

It is therefore an object of the invention to develop a process for producing gel, glass or ceramic layers, in particular SiO₂ layers and doped SiO₂ layers, on substrates, by means of which thick layers which are free of cracks and are suitable, in particular, for optical or optoelectronic applications can be obtained by means of a coating procedure.

This has surprisingly been able to be achieved by a process for producing substrates with at least one layer comprising an inorganic gel, glass, glass-ceramic or ceramic material, in which a coating composition comprising nanosize particles and water soluble organic flexibilizers is applied to the substrate and heat treated.

It is particularly surprising that the layers produced in the process of the invention after burning-out of the flexibilizer have a high porosity (e.g. an index of refraction of n_{D}=1.22, which corresponds to a porosity of 52%) and do not display crack formation during further densification (e.g. at about 1100° C.) below the theoretical T_{g} despite high shrinkage (e.g. about 40-50% in the thickness), as is known in the case of all other systems known hitherto. This appears to be due to the agglomerate-free arrangement of the nanosize particles in the gel layer. The highly porous layers are transparent, which indicates that the pores present therein are predominantly or virtually exclusively nanopores. These nanopores evidently make crack-free sintering at T_{g} possible.

The process of the invention thus makes it possible to produce crack-free thick films having a thickness up to a number of microns, which can be sintered to dense layers by means of thermal densification. Firstly, the diffusion distances which have to be covered during sintering are small, so that crack-free densification is successfully obtained. Secondly, the layers remain transparent in each stage from gel to glass, so that it is possible to set the index of refraction and/or the dielectric constant via the densification temperature. Layers having thicknesses in the micron range or gel bodies have hitherto always been white. The large pores present in the layers according to the prior art not only contribute to light scattering but also lead to crack formation on densification. In contrast thereto, the nanoporous layers obtainable by the process of the invention make possible the formation of transparent and crack-free layers at each stage.

As substrate, it is possible to use any thermally stable substrate: In principle, it is also possible to use metal substrates, but this is not preferred. On the other hand, semimetals and, in particular, semiconductors are suitable substrates. Preferred substrates are glass substrates such as float glass, borosilicate glass, lead crystal or fused silica, glass-ceramic substrates, semiconductor substrates such as doped or undoped Si or Ge or ceramic substrates such as Al₂O₃, ZrO₂ or SiO₂ mixed oxides. Particular preference is given to glass and semiconductor substrates, in particular substrates comprising silicon or silicon dioxide. The silicon can be doped, e.g. with P, As, Sb and/or B. The silicon dioxide can also be doped. Examples of dopants are indicated below in the description of the nanosize particles. The substrates can be, for example, silicon wafers or silicon coated with silicon dioxide, as are used in the semiconductor industry and in optoelectronics.

Of course, the substrate has to be chosen so that it withstands the necessary thermal treatment. The substrate can have been pretreated, e.g. by structuring or, in particular, by partial coating, e.g. by means of printing techniques. For example, optical and/or electrical microstructures, e.g. optical waveguides or conductor tracks, can be present.

The coating composition is, in particular, a coating sol comprising a flexibilizer in the form of a water-soluble organic polymer and/or oligomer and nanosize particles.

The nanosize particles are, in particular, nanosize inorganic particles. They are preferably nanosize nonmetal oxide and/or metal oxide particles. The particle size is, for example, in the range below 100 nm. In particular, the particle sizes are in the range from 1 nm to 40 nm, preferably from 5 nm to 20 nm, particularly preferably from 8 nm to 12 nm. The sizes indicated refer to average particle diameters. This material can be used in the form of a powder, but is preferably used in the form of a sol.

Examples of nanosize particles which can be used are oxides or hydrated oxides of Si, Al, B, Zn, Cd, Ti, Zr, Ce, Sn, Sb, In, La, Fe, Cu, Ta, Nb, V, Mo or W, e.g. anhydrous or hydrated oxides such as ZnO, CdO, SiO₂, TiO₂, ZrO₂, CeO₂, SnO₂, Sb₂O₃, AlOOH, Al₂O₃, In₂O₃, La₂O₃, Fe₂O₃, Cu₂O, Ta₂O₅, Nb₂O₅, V₂O₅, MoO₃ or WO₃, phosphates, silicates, zirconates, aluminates, stannates and corresponding mixed oxides (for example, those having a perovskite structure, e.g. BaTiO₃ and PbTiO₃). These can be used individually or as a mixture of two or more thereof. Preferred nanosize particles are SiO₂, CeO₂, Al₂O₃, AlOOH, TiO₂, ZrO₂, SnO₂, Sb₂O₃ and ZnO. Very particular preference is given to using SiO₂ as nanosize particle.

The nanosize particles can be produced by known methods. SiO₂ particles can be prepared, for example, via base-catalyzed hydrolysis and condensation of silicon alkoxides or via other known methods for producing silica sols, e.g. via the water glass route. Pyrogenic or thermal methods of preparation are also known. Such SiO₂ particles are commercially available, e.g. as silica sols. Analogous processes are also known for other oxide particles. Preference is given to using aqueous sols of the nanosize particles, e.g. aqueous silica sols and in particular colloidal, electrostatically stabilized aqueous silica sols.

In addition to the nanosize particles, dopants can also be employed. Suitable dopants are generally all glass- or ceramic-forming elements. Examples of glass- or ceramic forming components (in their oxide form) for doping are B₂O₃, Al₂O₃, P₂O₅, GeO₂, Bi₂O₃ or oxides of gallium, tin, arsenic, antimony, lead, niobium and tantalum, network transformers such as alkali metal oxides and alkaline earth metal oxides, components which increase the index of refraction, e.g. PbO, TiO₂, ZrO₂, HfO₂, Ta₂O₅, Tl₂O, optically active components such as rare earth oxides, e.g. Er₂O₃, Yb₂O₃, Nd₂O₃, Sm₂O₃, Ce₂O₃, Eu₂O₃, transition elements, e.g. La₂O₃, Y₂O₃, WO₃, and also In₂O₃, SnO or SnO₂ and Sb₂O₃. For the purposes of the present invention, optically active components are, in particular, components which are optically active in the sense of photoluminescence in the visible and NIR spectral region or 2-photon absorption processes (upconversion).

Doping is carried out, for example, in concentrations of from 0% to 15 mol %, preferably from 0% to 10 mol % and particularly preferably from 0% to 7.5 mol %, measured on the total oxide content. Doping is carried out, for example, by addition of the doping components as water-soluble salts, as alkoxides or as soluble complexes, e.g. acetylacetonates, acid complexes or amine complexes, to the coating sol and, if appropriate, hydrolysis.

The principle of doping also makes it possible to produce homogeneous multicomponent glass layers having thicknesses in the micron range. It is found that the nanosize particles, used, e.g. the silica sols, in combination with the flexibilizer, e.g. a PVA binder, gives stable sols and gel layers both in acidic medium and in basic medium, so that a variety of dopants are possible. Homogenization occurs during sintering. Here too, the nanodisperse state of the SiO₂ xerogel framework is important to achieve homogeneous distribution of the element(s) in a short time. A further advantage is that the genuine nanoporosity results in complete densification being achieved at T_{g}. Only in this way is it possible to avoid known phase separation processes, especially in the case of low-dopant SiO₂ compositions, which are unavoidable at relatively high temperatures and often lead to coatings which are not transparent. This is particularly important for the production of optically active layers, since phase separation phenomena increase concentration quenching of the emission in these layers.

In addition, water-soluble organic flexibilizers are used in the coating composition. These are, in particular, water-soluble organic polymers and/or oligomers, preferably water-soluble organic polymers, e.g. water-soluble organic binders. These are, for example, polymers and/or oligomers which contain polar groups such as hydroxyl groups, primary, secondary or tertiary amino groups, carboxyl groups or carboxylate groups. Typical examples are polyvinyl alcohol, polyvinylpyrrolidone, polyacrylamide, polyvinyl pyridine, polyallylamine, polyacrylic acid, polyvinyl acetate, polymethyl methacrylate, starch, gum arabic, other polymeric alcohols such as polyethylene-polyvinyl alcohol copolymers, polyethylene glycol, polypropylene glycol and poly(4-vinylphenol). A preferred flexibilizer is polyvinyl alcohol, e.g. the commercially available Mowiol® 18-88 from Hoechst. It is also possible to use polyvinyl alcohols having, for example, an MW of 1200. The flexibilizers can be used individually or as a mixture of two or more thereof.

In contrast to the solvent, the flexibilizers cannot be distilled off even at elevated temperatures, but instead are burned out by means of the heat treatment, i.e. they cannot be vaporized without decomposition. They are, in particular, substances which are solid at room temperature.

Apart from the nanosize particles and the flexibilizers, the coating composition further comprises, in particular, one or more solvents as third components. It is possible to use all suitable solvents known to those skilled in the art. Examples of suitable solvents are water, alcohols, preferably lower aliphatic alcohols, e.g. C₁-C₄-alcohols such as methanol, ethanol, 1-propanol, i-propanol and 1-butanol, ketones, preferably lower dialkyl ketones, e.g. C₁-C₄-dialkyl ketones such as acetone and methyl isobutyl ketone, ethers, preferably lower dialkyl ethers, e.g. C₁-C₄-dialkyl ethers such as dioxane and THF, amides such as dimethylformamide, and acetonitrile. The solvents can be used alone or as mixtures.

Particularly preferred solvents are water, alcohol/water mixtures having alcohol contents of from 0% to 90% by volume, mixtures of water and tetrahydrofuran (THF) having THF contents of from 0% to 90% by volume, other single-phase mixtures of water and organic solvents such as dioxane, acetone or acetonitrile, with a minimum water content of 10% by volume being preferred. Particularly preferred solvents contain at least 10% by volume of water. The water content in the solvent is particularly preferably >50%, in particular >90%. Preference is therefore given to using aqueous costing compositions, i.e. those having a minimum-water content.

The proportion of solvent in the coating composition depends largely on the coating method chosen. In the case of coatings to be applied by spraying it is, for example, about 95%, in the case of coatings to be applied by spin coating or dipping it is, for example, about 80%, in the case of coatings to be applied by doctor blade coating it is, for example, about 50% and in the case of printing pastes it is, for example, about 30%.

The coating composition can in principle further comprise other additives, e.g. fluorosilane condensates as are described, for example, in EP 587667.

The flexibilizer is compounded with the nanosize particles (and the abovementioned solvents) to give a coating sol in such a way that this flexibilizer sterically stabilizes the SiO₂ nanoparticles on drying of the corresponding sol-gel layers. As a result, no agglomerates or aggregates which would lead to large pores are formed on drying of the layers.

It has been found to be particularly advantageous for the volume ratio of flexibilizer to the nanosize particles to be selected so that the flexibilizer approximately fills the voids present between the particles in the solvent-free state. Of course, good results can also be achieved in the case of not excessively large deviations from this ratio. For this reason, the proportion of flexibilizer is preferably selected so that it largely fills the voids between the nanoparticles after evaporation of the solvent, i.e. the volume ratio of nanoparticles to flexibilizer is preferably from 72:28 to 50:50, particularly preferably from 70:30 to 60:40 and in particular from 68:32 to 62:38, e.g. about 65:35.

The production of the layers can be carried out using all customary wet processes. The coating composition is, for this purpose, applied to the substrate by customary coating methods, e.g. dipping, flooding, drawing, casting, spin coating, squirting, spraying, painting, doctor blade coating, rolling or customary printing techniques, e.g. using printing pastes. Owing to the abovementioned disadvantages, electrophoretic coating processes are less suitable or not suitable at all.

As a result of the heat treatment, the coating composition applied to the substrate is dried, the flexibilizer is burned out and, if appropriate, the coating is then partially or fully densified. Partial or complete drying can also be carried out prior to the heat treatment, e.g. by means of simple ventilation. However, the removal of the solvent advantageously occurs by means of the heat treatment.

For the heat treatment, it is possible to use conventional methods, e.g. heating in an oven or “rapid thermal annealing” (flash annealing, flame treatment), the latter particularly for densification. It is also possible, for example, to conceive of the use of heat radiators, e.g. IR radiators or lasers. Heat treatment is carried out, for example, under an oxygen containing or inert atmosphere, e.g. nitrogen, or air. However, the atmosphere can also comprise, for example, other components such as ammonia, chlorine or carbon tetrachloride, either alone or as additional components.

The removal of the solvent by evaporation and the flexibilizer by burning out are carried out at, for example, temperatures of up to about 450° C., e.g. by heating in an oven/furnace. The densification temperatures depend on the desired degree of residual porosity and on the composition. In the case of glass layers, they are generally in the range from 450° C. to 1200° C., and in the case of ceramic layers they are generally in the range from 500° C. to 2000° C. The heat treatment is preferably carried out using temperature programs in which the parameters such as heating rates, hold temperatures and temperature ranges are regulated. These are known to those skilled in the art.

After drying, a gel still containing the flexibilizer is obtained, but in the case of, for example, relatively high-boiling solvents, parallel removal is also possible. After burning out, a gel, more precisely a xerogel, having pores, preferably substantially nanopores, and no longer containing any significant amount of organic constituents (carbon-free) is obtained. This inorganic gel or xerogel can be converted into a glass-like, glass-ceramic-like or ceramic-like layer by partial or full densification. In each stage from gel to glass, the layers remain transparent. This makes it possible to set the index of refraction and/or the dielectric constant via the densification temperature.

Layers having dry layer thicknesses of, for example, from 0.1 μm to 30 μm, preferably from 5 μm to 20 μm, particularly preferably from 8 μm to 12 μm, can be obtained. This applies both to the nanoporous inorganic layers and the dense inorganic layers. According to the invention, it is surprisingly possible to obtain crack free thick films, e.g. having a thickness of more than 1 μm, in particular more than 3 μm or 5 μm or even above 8 μm, which are also transparent and thus suitable for optical applications.

The gel layers after removal of the solvent but not the flexibilizer have, for example, thicknesses of from 0.5 μm to 200 μm, preferably from 5 μm to 50 μm and particularly preferably from 10 μm to 20 μm.

The inorganic layers obtained in the process of the invention can also be structured, in particular microstructured. Structuring or microstructuring can be carried out, in particular, for producing optical or electronic structures. It can be carried out in the gel layer or in the densified, partially densified or undensified inorganic layers. Structuring is preferably carried out in the gel state, in particular after removal of the solvent but before removal of the flexibilizer. Methods known from the prior art, e.g. photolithography, embossing or etching and masking processes, are used for this purpose. Microstructuring prior to thermal densification allows the production of particularly thick (8 μm to 20 μm) densified microstructures.

The coated substrates produced are particularly suitable as optical, optoelectronic, electronic, micromechanical or dirt-repellent components. Typical examples of applications are passive and active optical waveguides, buffer and cladding layers for passive and active optical waveguides on glass, ceramic and Si substrates, dielectric layers and microstructures on glass, ceramic and silicon substrates for producing semiconductor components, siliceous layers and layers comprising alkali metal silicates and also microstructures for thermal and anodic bonding of silicon substrates, optical components, e.g. gratings and light-scattering structures, microlenses, microcylinder lenses, microfresnel lenses or arrays of these, microreactors or transparent dirt-repellent microstructures.

The following examples illustrate the invention.

A) Preparation of the Coating Sols

### EXAMPLE 1

Synthesis of the SiO₂ Sol

To synthesize the SiO₂ sols, use is made of two different silica sols. One silica sol was synthesized beforehand from TEOS using ammonia in ethanol, with the process being carried out so that the SiO₂ particle size after the synthesis was 10 nm and the solids content was set to 5.58% by weight (this silica sol is referred to as KS 10). The second silica sol used is commercially available (Levasil® VPAc 4039, Bayer). To prepare the sol, 75 g of KS 10 and 23.25 g of VPAc 4039 are combined and 39.06 g of a 10% strength by weight aqueous solution of the organic binder PVA (Mowiol® 18-88, Hoechst) are added to this solution. After stirring at room temperature, a homogeneous mixture is obtained. The desired solids content (25% by weight, based on the oxide content of the sol) is set by removal of solvent by distillation on a rotary evaporator. After concentration of the sol, the pH is set to 9-9.5 by dropwise addition of 0.4 g of a 25% strength ammonia solution. Before the coating procedure, the sols are filtered through a spray filter (1.2 μm).

### EXAMPLE 2

Synthesis of an SiO₂ Sol Doped with Aluminum Oxide (95 mol % SiO₂, 5 mol % Al₂O₃)

40 g of 1 molar aqueous HNO₃ is slowly added dropwise to 100 g of KS 10 and the mixture is heated to 60° C. A solution of 2.01 g (9.8×10⁻³ mol) of aluminum isopropoxide in 40 ml of tetrahydrofuran is added dropwise to this solution while hot. 21.28 g of the organic binder PVA (10% strength by weight solution in water) are then added. The solvent is subsequently removed by distillation on a rotary evaporator until the solids content is 10% by weight (based on the oxide content of the sol). Before coating, the sol is filtered through a spray filter to 1.2 μm.

### EXAMPLE 3

Synthesis of an SiO₂ Sol Doped with Al₂O₃ and PbO (92.5 mol % SiO₂, 5 mol % Al₂O₃, 2.5 mol % PbO)

40 g of 1 molar aqueous HNO₃ is slowly added dropwise to 100 g of KS 10 and the mixture is heated to 60° C. A solution of 2.053 g (1.00×10⁻³ mol) of aluminum isopropoxide in 40 ml of tetrahydrofuran is added dropwise to this solution while hot. After cooling to room temperature, 0.832 g (2.51×10⁻³ mol) of lead nitrate is dissolved in the reaction mixture. 23.02 g of the organic binder PVA (10% strength by weight solution in water) are then added. The solvent is subsequently removed by distillation on a rotary evaporator until the solids content is 10% by weight (based on the oxide content). Before coating, the sol is filtered through a spray filter to 1.2 μm.

### EXAMPLE 4

Synthesis of an SiO₂ Sol Doped with Al₂O₃ and Er₂O₃ (92.5 mol % SiO₂, 5 mol % Al₂O₃, 2.5 mol % Er₂O₃)

40 g of 1 molar aqueous HNO₃ is slowly added dropwise to 100 g of KS 10 and the mixture is heated to 60° C. A solution of 2.053 g (1.00×10⁻³ mol) of aluminum isopropoxide in 40 ml of tetrahydrofuran is added dropwise to this solution while hot. After cooling to room temperature, 2.23 g (5.02×10⁻³ mol) of erbium nitrate pentahydrate are dissolved in the reaction mixture. 23.28 g of the organic binder PVA (10% strength by weight solution in water) are then added. The solvent is subsequently removed by distillation on a rotary evaporator until the solids content is 10% by weight (based on the oxide content). Before coating, the sol is filtered through a spray filter to 1.2 μm.

### EXAMPLE 5

Synthesis of an SiO₂ Sol Doped with B₂O₃ (97.5 mol % SiO₂, 2.5 mol % B₂O₃)

40 g of 1 molar aqueous HNO₃ is slowly added dropwise to 100 g of KS 10 and the mixture is heated to 60° C. After cooling to room temperature, 0.696 g (0.00476 mol) of triethyl borate is dissolved in the reaction mixture. 20.12 g of the organic binder PVA (10% strength by weight solution in water) are then added. The solvent is subsequently removed by distillation on a rotary evaporator until the solids content is 10% by weight (based on the oxide content). Before coating, the sol is filtered through a spray filter to 1.2 μm.

### EXAMPLE 6

Synthesis of an SiO₂ Sol Doped with P₂O₅ (97.5 mol % SiO₂, 5 mol % P₂O₅)

40 g of 1 molar aqueous HNO₃ is slowly added dropwise to 100 g of KS 10 and the mixture is heated to 60° C. After cooling to room temperature, 0.694 g (0.00489 mol) of phosphorus pentoxide is dissolved in the reaction mixture. 20.21 g of the organic binder PVA (10% strength by weight solution in water) are then added. The solvent is subsequently removed by distillation on a rotary evaporator until the solids content is 10% by weight (based on the oxide content). Before coating, the sol is filtered through a spray filter to 1.2 μm.

### EXAMPLE 7

Synthesis of a Sol for a Porous SiO₂-CeO₂ layer (50 mol % SiO₂, 50 mol % CeO₂)

100 g of KS 10 are slowly added dropwise to 6.5 g of 1 molar aqueous HNO₃ while stirring. 40 g of acetate-stabilized, particulate CeO₂ sol (CeO₂ ACT, 20% by weight, AKZO-PQ) are then slowly added at room temperature while stirring. 37.7 g of the organic flexibilizer PVA-18-88 are then added as a 10% strength by weight solution in water. Before coating, this sol is filtered through a spray filter to 1.2 μm.

B) Coating

The sols synthesized as indicated above are applied by means of customary coating methods (e.g. spin coating, spraying, dipping or doctor blade coating) to various substrates, preferably SiO₂ and silicon.

C) Heat Treatment of the Layers

Densification of the layers is carried out in a muffle furnace in accordance with a set temperature program. Here, the layers are heated from room temperature to 256° C. at a heating rate of 0.8 K/min, and the temperature is held at 250° C. for 1 hour. The layers are heated from 250° C. to 450° C. at a heating rate of 0.8 K/min and this temperature is once again held for 1 hour. The final densification temperature for the undoped SiO₂ layers is 1100° C. which is held for 1 hour. Final densification temperatures of from 500 to 1000° C. lead to porous layers having a correspondingly lower index of refraction. The heating rate for the densification for 450 to 1100° C. is 2 K/min. The doped layers are densified at the same heating rate to 1000° C. for 1 hour.

Crack-free and transparent layers are obtained in each case.

1. A process for producing substrates with at least one layer comprising an inorganic gel, glass, glass-ceramic or ceramic material, in which a coating composition comprising nanosize particles and water-soluble organic flexibilizers is applied to the substrate and heat treated.

2. The process as claimed in claim 1, characterized in that the coating applied to the substrate is partially or fully densified by heat treatment.

3. The process as claimed in claim 1 or 2, characterized in that the coating applied to the substrate is dried to a gel and structured or the inorganic gel, glass, glass-ceramic or ceramic layer is structured.

4. The process as claimed in any of claims 1 to 3, characterized in that nanosize nonmetal oxide and/or metal oxide particles selected from the group consisting of SiO₂, CeO₂, Al₂O₃, AlOOH, TiO₂, ZrO₂, SnO₂, Sb₂O₃ and ZnO or mixtures or mixed oxides thereof are used as nanosize particles.

5. The process as claimed in any of claims 1 to 4, characterized in that the coating composition further comprises compounds of glass- or ceramic-forming elements, network transformers, components which increase the refractive index and/or optically active components as dopants.

6. The process as claimed in any of claims 1 to 6, characterized in that a flexibilizer selected from the group consisting of polyvinyl alcohol, polyvinylpyrrolidone, polyacrylamide, polyvinylpyridine, polyallylamine, polyacrylic acid, polyvinyl acetate, polymethyl methacrylate, polyethylene-polyvinyl alcohol copolymers, polyethylene glycol, polypropylene glycol and poly(4-vinylphenol) is used.

7. The process as claimed in any of claims 1 to 6, characterized in that the coating composition is applied to the substrate by spraying, dipping, spin coating, flooding, doctor blade coating, rolling or printing techniques.

8. The process as claimed in any of claims 1 to 7, characterized in that a glass, glass-ceramic, semiconductor or ceramic substrate is used.

9. The process as claimed in any of claims 1 to 8, characterized in that silicon dioxide, silicon, doped silicon dioxide or doped silicon is used as substrate.

10. A substrate with at least one thick film comprising an inorganic gel, glass, glass-ceramic or ceramic material, obtainable by the process as claimed in any of claims 1 to 9.

11. A substrate as claimed in claim 10, characterized in that the dry layer thickness of the inorganic gel, glass, glass-ceramic or ceramic layer is at least 1 μm.

12. A substrate as claimed in claim 10 or 11, characterized in that the inorganic layer is transparent.

13. The use of a substrate as claimed in any of claims 10 to 12 as optical, optoelectronic, electronic, micromechanical or dirt-repellent components.
